(19) United States
(12) Patent Application Publication
(10) Pub. No.: US 2011/0031766 A1
(43) Pub. Date: Feb. 10, 2011

(54) CASING WITH MAGNETIC LATCH

(76) Inventors: Chieh Huang, Shulin City (TW); Shan-Yi Yang, Shulin City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/536,115

(22) Filed: Aug. 5, 2009

(51) Int. Cl. E05C 19/16; E05D 7/00

(52) U.S. Cl. 292/251.5; 16/221

(57) ABSTRACT

A casing with magnetic latch that is easy to produce and a cover can be quickly opened. The casing has a first magnetic unit and a third magnetic unit respectively mounted in the cover and base. A second magnetic unit is slidably mounted between the first and third magnetic units. When the cover is closed, attraction between the first and third magnetic units holds the cover firmly against the base. When the second magnetic unit is slid between the first and third magnetic units, repulsion between the first and second magnetic units pushes the cover away from the base.

### BACKGROUND OF THE INVENTION

1. Field of the Invention

The present invention relates to a casing with magnetic latch, especially to a casing with magnetic latch for a portable electronic device.

2. Description of the Prior Arts

A portable electronic device has a cover and a base pivotally mounted to each other. Latching devices are mounted between the cover and the base to selectively hold the cover against the base. One of the engaging devices is a magnetic latch.

With reference to FIGS. 8 and 9, a conventional casing with magnetic latch comprises a base (90), a bottom magnet (91), a cover (92) and a top magnet (93). The bottom magnet (91) is mounted slidably on the base (90). The cover (92) is connected pivotally to the base (90). The top magnet (93) is mounted securely on the cover (92). When the cover (92) is closed relative to the base (90), the south pole of the bottom magnet (91) corresponds to the north pole of the top magnet (93) while the north pole of the bottom magnet (91) corresponds to the south pole of the top magnet (93) to generate attraction. The attraction between the magnets (91, 93) holds the cover (92) securely against the base (90). When the cover (92) is opened, the bottom magnet (91) is slid transversely. Then the south pole of the bottom magnet (91) corresponds to the south pole of the top magnet (93) to generate repulsion. The repulsion pushes the cover (92) to pivot away from the base (90).

The conventional casing with magnetic latch has the following disadvantages.

For users, the bottom magnet (91) does not quickly push the cover (92) away from the base (90). The bottom magnet (91) must be slid far enough so that the south pole of the bottom magnet (91) does not align with the north pole of the top magnet (93) and instead aligns with the south pole of the top magnet (93) to provide enough repulsion. Therefore, the conventional casing with magnetic latch does not allow the cover (92) to be opened quickly.

For manufacturers, the channels along which the bottom magnet (91) slides must be precisely made to provide a precise sliding length for the bottom magnet (91). If the sliding length is too short, the bottom magnet (91) does not slide far enough to provide repulsion. If the sliding length is too large, the bottom magnet (91) slides too far and the top magnet (93) does not provide repulsion. Therefore, manufacturing cost is raised by such precision requirements.

To overcome the shortcomings, the present invention provides a casing with magnetic latch to mitigate or obviate the aforementioned problems.

### SUMMARY OF THE INVENTION

The main objective of the present invention is to provide a casing with magnetic latch that is easy to produce and allows a cover to be opened quickly. The casing with magnetic latch has a first magnetic unit and a third magnetic unit mounted respectively mounted in a cover and base. A second magnetic unit is slidably mounted between the first and third magnetic units. When the cover is closed, attraction between the first and third magnetic units holds the cover firmly against the base. When the second magnetic unit is slid between the first and third magnetic units, repulsion between the first and second magnetic units pushes the cover away from the base.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a casing with magnetic latch in accordance with the present invention;

FIG. 2 is another perspective view of the casing with magnetic latch in FIG. 1;

FIG. 3 is an exploded perspective view of a hinge of the casing with magnetic latch in FIG. 1;

FIG. 4 is an operational enlarged side view in partial section of the casing with magnetic latch in FIG. 1, shown closing;

FIG. 5 is an operational enlarged side view in partial section of the casing with magnetic latch in FIG. 1, shown opening;

FIG. 6 is an operational enlarged side view in partial section of a second embodiment of a casing with magnetic latch in accordance with the present invention, shown closing;

FIG. 7 is a perspective view of a third embodiment of a casing with magnetic latch in accordance with the present invention;

FIG. 8 is a perspective view of the conventional casing with magnetic latch in accordance with the prior art; and

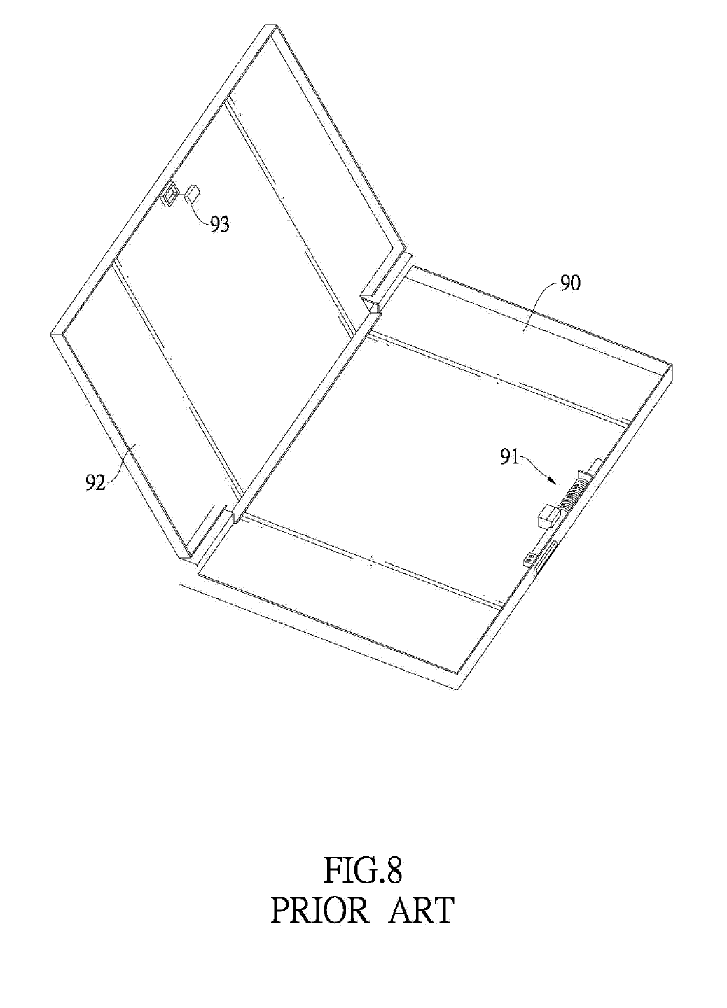

FIG. 9 is an enlarged front view in partial section of the conventional casing with magnetic latch in FIG. 8.

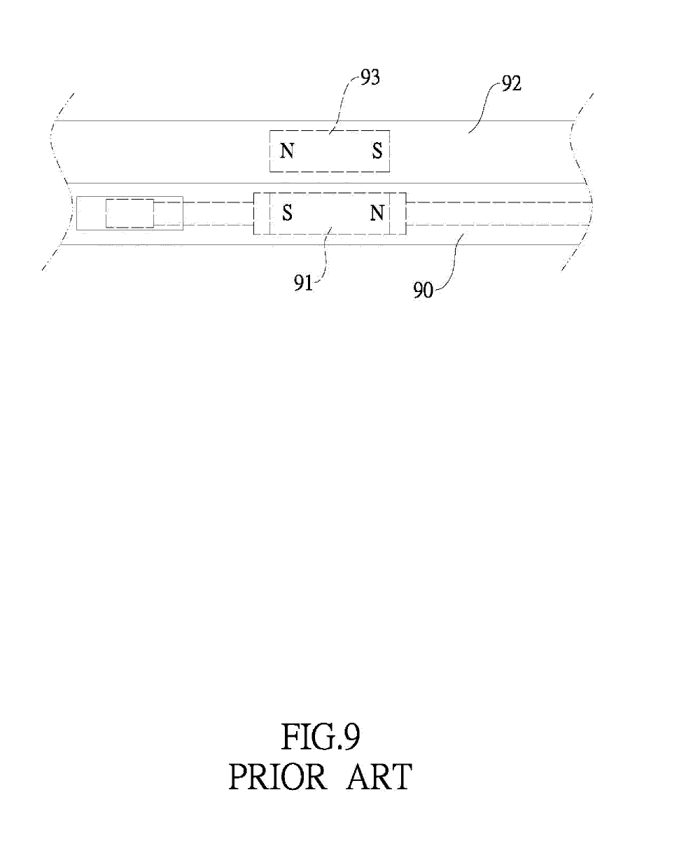

### DETAILED DESCRIPTION OF THE PREFERRED EMBODIMENTS

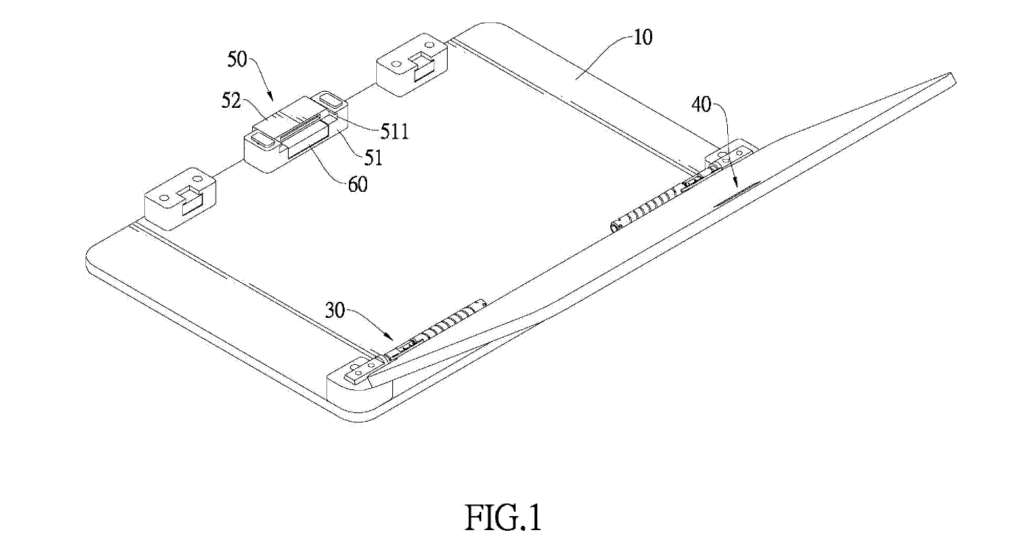

With reference to FIG. 1, a casing with magnetic latch in accordance with the present invention comprises a base (10), a cover (20), a hinge (30), a first magnetic unit (40), a second magnetic unit (53), an actuating assembly (50) and a third magnetic unit (60).

A rear end of the cover (20) is connected pivotally to a rear end of the base (10) via the hinge (30);

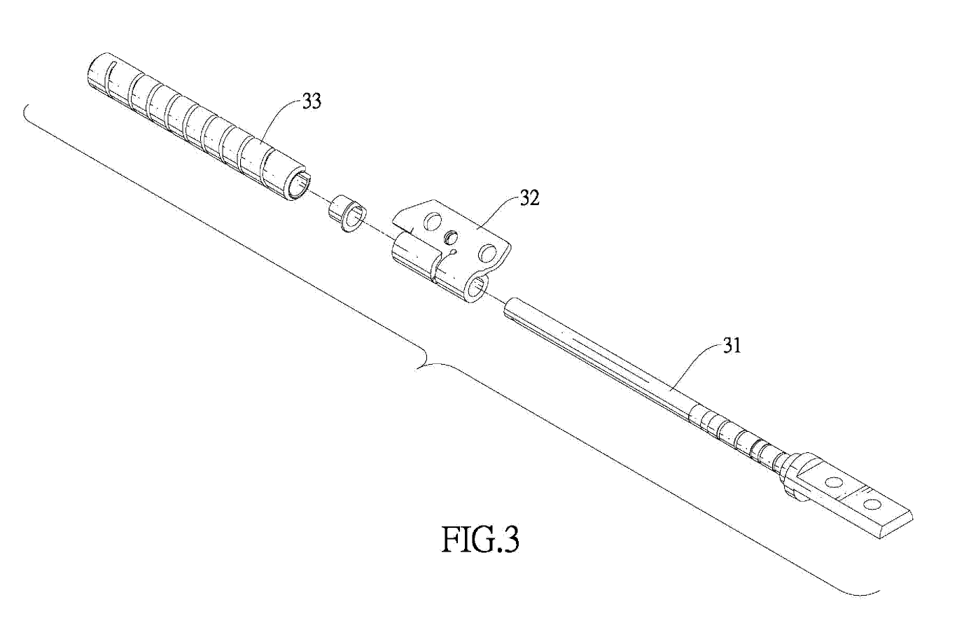

With further reference to FIG. 3, in a preferred embodiment, the hinge (30) comprises a pintle (31), a sleeve (32) and a twisted spring (33). The pintle (31) is attached securely to the base (10). The sleeve (32) is mounted rotatably around the pintle (31) and is attached securely to the cover (20). The twisted spring (33) is mounted around the pintle (31) and has one end connected to the pintle (31) and the other end is connected to the sleeve (32). When the cover (20) is closed relative to the base (10), the twisted spring (33) is extended to store a resilient force. When the cover (20) is opened relative to the base (10), the twisted spring (33) provides the resilient force to aid opening of the cover (20). In the prefer embodiment, the twisted spring (33) provides the resilient force strong enough to urge the cover (20) rotatable relative to the base (10) to a predetermined viewing angle, for example, 90 degrees or more when the cover (20) is disengaged from the base (10) by means described as the following. This is convenient for users' viewing.

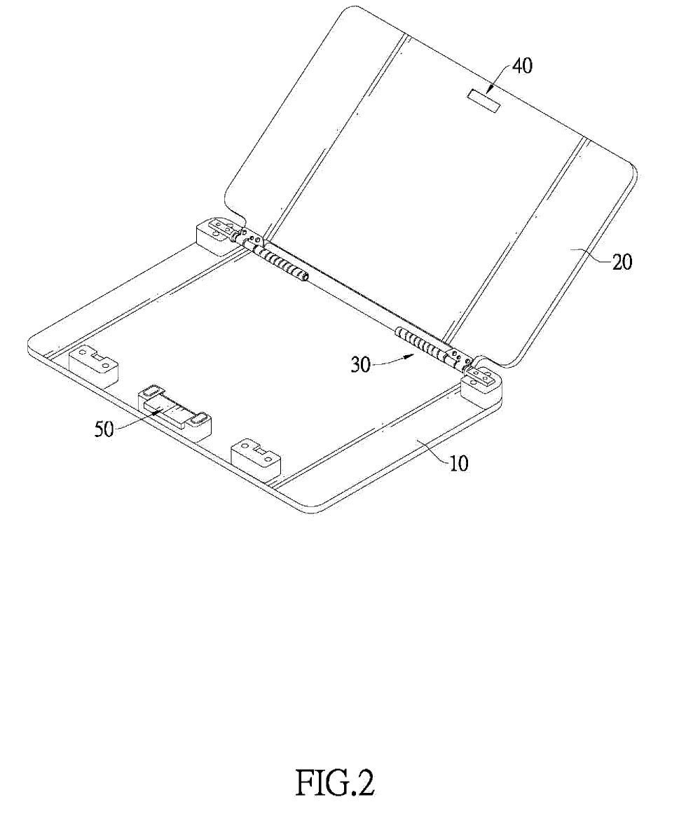

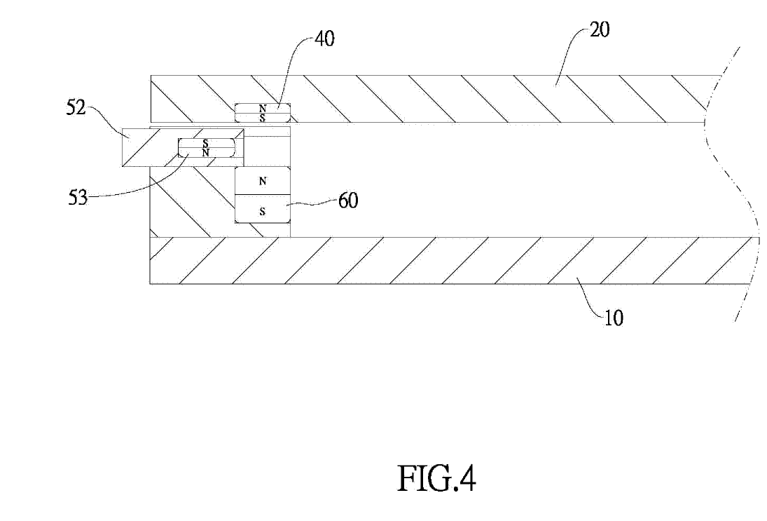

With reference to FIGS. 2 and 4, the first magnetic unit (40) is mounted securely on the cover (20) near a front end of the cover (20) and has an upper pole and a lower pole.

With reference to FIGS. 1, 2 and 4, the second magnetic unit (53) is mounted slidably on the base (10), selectively overlaps the first magnetic unit (40) and has an upper pole and a lower pole. The upper pole of the second magnetic unit (53) is the same with the lower pole of the first magnetic unit (40) to provide repulsion. Additionally, the second magnetic unit (53) may be mounted slidably on the base (10).

The actuating assembly (50) is connected to the base (10) near a front end of the base (10). In a preferred embodiment, the actuating assembly (50) comprises a seat (51) and a shell (52). The seat (51) is attached securely to the base (10) and has two side channels (511). The shell (52) is mounted slidably between the channels (511). The second magnetic unit (53) is mounted securely in the shell (52).

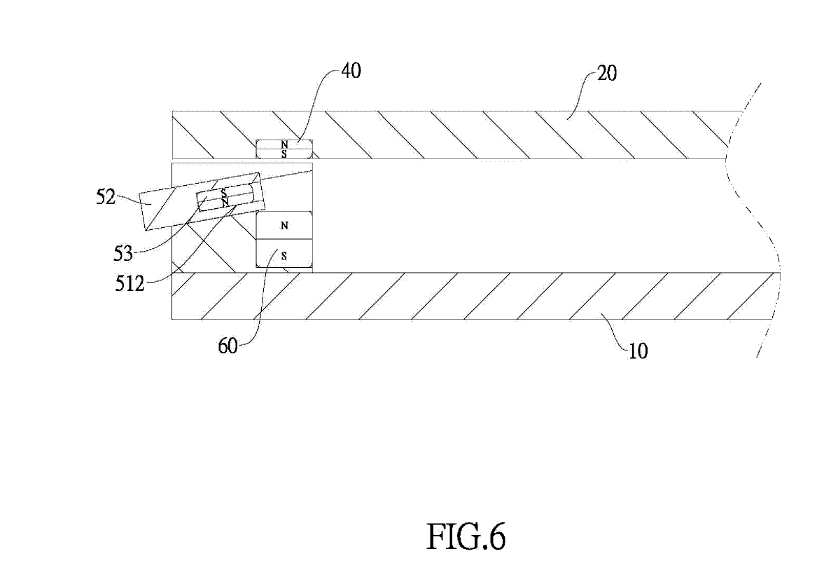

With reference to FIG. 6, the seat (51) may have an inclined surface (512) and the shell (52) slides on the inclined surface (512). When an external force is provides, the shell (52) slides upward along the inclined surface (512). When the external force is removed, the shell (52) slides downward along the inclined surface (512).

With reference to FIG. 4, the third magnetic unit (60) is attached securely to the base (10) near the front end of the base (10), may be mounted securely in the seat (51), aligns with the first magnetic unit (40) and has an upper pole and a lower pole. The upper pole of the third magnetic unit (60) is contrary to the lower pole of the first magnetic unit (40) to provide attraction. The upper pole of the third magnetic unit (60) is the same with the lower pole of the second magnetic unit (53) to provide repulsion. The first, second and third magnetic units (40, 53, 60) may be permanent magnets.

With reference to FIG. 4, when the cover (20) is closed relative to the base (10), the cover (20) is firmly held against the base (10) because of attraction between the lower pole of the first magnetic unit (40) and the upper pole of the third magnetic unit (60).

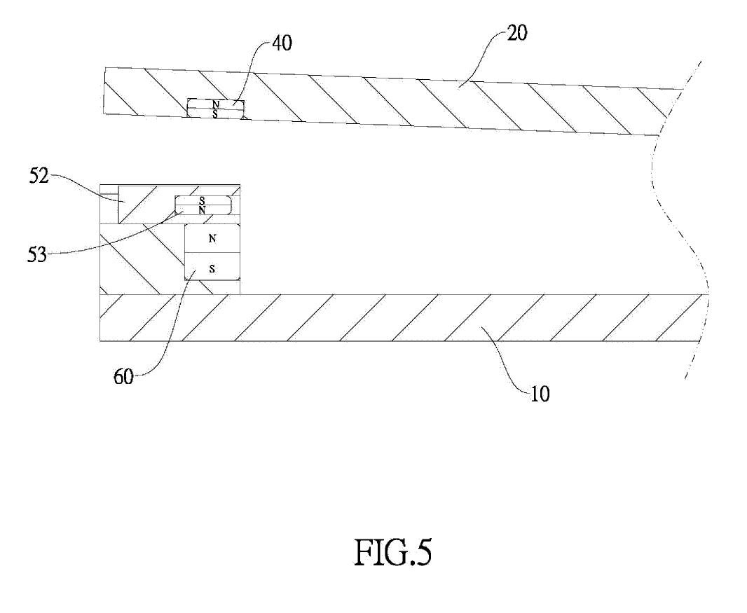

With reference to FIG. 5, when the second magnetic unit (53) is pushed to slide between the first and third magnetic units (40, 60), the second magnetic unit (53) quickly interrupts magnetic attraction between the first and third magnetic units (40, 60) and repulsion between the upper pole of the second magnetic unit (53) and the lower pole of the first magnetic unit (40) predominates and pushes the cover (20) to pivot away from the base (10). Then the external force to push the second magnetic unit (53) is removed so that the repulsion between the lower pole of the second magnetic unit (53) and the upper pole of the third magnetic unit (60) pushes the second magnetic unit (53) to slide back. Therefore, when the cover (20) is closed again, the attraction between the first and third magnetic unit (40, 60) is successfully generated to hold the cover (20) to firmly against the base (10) again.

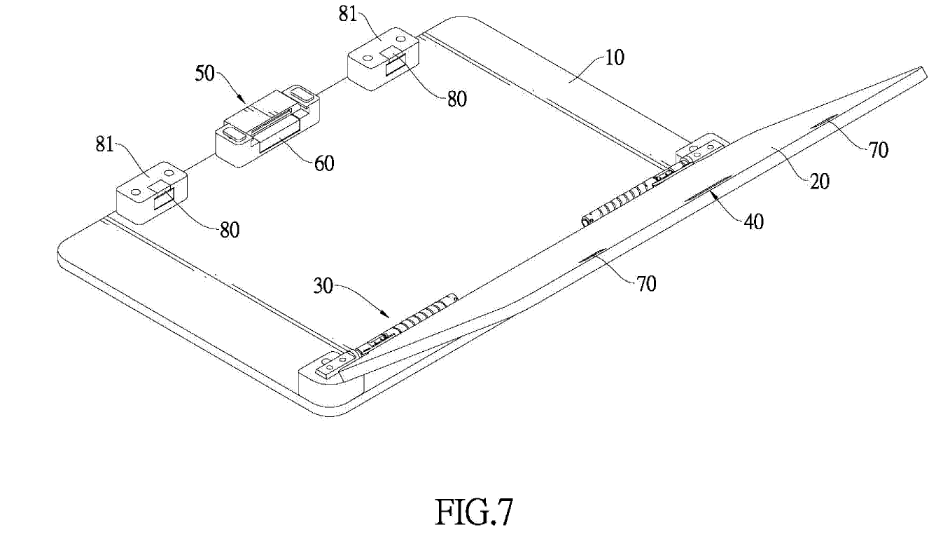

With reference to FIG. 7, in another preferred embodiment, two magnets (70) are attached securely to the cover (20), and the first magnetic unit (40) is located between the magnets (70). Two metal members (80) are attached securely to the base (10) and respectively align with the magnets (70), and the second magnetic unit (53) is located between the metal members (80). Each metal member (80) may be iron. When the cover (20) is closed relative to the base (10), the attraction between the magnets (70) and the metal members (80) holds the cover (20) to firmly against the base (10).

The casing with magnetic latch as described has the following advantages. The attraction to hold the cover (20) on the base (10) and the repulsion to push the cover (20) pivoting away from the base (10) are generated by different sets of elements. Once the second magnetic unit (53) is slid, the repulsion is generated to push the cover (20) to pivot away from the base (10) once the second magnetic unit (53) overlaps the first magnetic unit (40). Therefore, the cover (20) is quickly opened. Furthermore, the sliding path for the second magnetic unit (53) need not to be made precisely because the second magnetic unit (53) need not fully overlap the first magnetic unit (40). Thus, the manufacture cost is decreased.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A casing with magnetic latch comprising:
a base;
a cover connected pivotally to the base;
a first magnetic unit attached securely to the cover;
a second magnetic unit mounted slidably either on the cover or on the base; and
a third magnetic unit attached securely to the base and aligning with the first magnetic unit; wherein
when the second magnetic unit stays away from the first and third magnetic units, an attraction is generated between the first and third magnetic units, and
when the second magnetic unit slides between the first and third magnetic units, repulsion is generated between the first and second magnetic units and between the second and third magnetic units.

2. The casing with magnetic latch as claimed in claim 1, wherein
the first magnetic unit is a permanent magnet and has an upper pole and a lower pole;
the second magnetic unit is a permanent magnet and has
an upper pole the same with the lower pole of the first magnetic unit; and
a lower pole; and
the third magnetic unit is a permanent magnet and has
an upper pole contrary to the lower pole of the first magnetic unit and the same with the lower pole of the second magnetic unit, and
a lower pole.

3. The casing with magnetic latch as claimed in claim 1 further comprising a hinge mounted between the cover and the base and having
a pintle attached securely to the base;
a sleeve mounted rotatably around the pintle and attached securely to the cover; and
a twisted spring mounted around the pintle and having one end connected to the pintle and the other end connected to the sleeve, wherein the twisted spring provides a resilient force strong enough to urge the cover rotatable relative to the base to a predetermined viewing angle.

4. The casing with magnetic latch as claimed in claim 2 further comprising a hinge mounted between the cover and the base and having
a pintle attached securely to the base;
a sleeve mounted rotatably around the pintle and attached securely to the cover; and
a twisted spring mounted around the pintle and having one end connected to the pintle while the other end connected to the sleeve, wherein the twisted spring provides a resilient force strong enough to urge the cover rotatable relative to the base to a predetermined viewing angle.

5. The casing with magnetic latch as claimed in claim 1 further comprising an actuating assembly connected to the base, wherein
the actuating assembly has
a seat attached securely on the base and having two side channels; and
a shell mounted slidably, between the channels; and
the second magnetic unit is mounted securely in the shell.

6. The casing with magnetic latch as claimed in claim 2 further comprising an actuating assembly connected to the base, wherein
the actuating assembly has
a seat attached securely on the base and having two side channels; and
a shell mounted slidably between the channels; and
the second magnetic unit is mounted securely in the shell.

7. The casing with magnetic latch as claimed in claim 5, wherein the seat has an inclined surface and the shell slides on the inclined surface.

8. The casing with magnetic latch as claimed in claim 6, wherein the seat has an inclined surface and the shell slides on the inclined surface.

9. A casing with magnetic latch comprising:
a base;
a cover connected pivotally to the base;
a first magnetic unit attached securely to the cover;
a second magnetic unit mounted slidably on the base;
two magnets attached securely to the cover, and the first magnetic unit located between the magnets; and
two metal members attached securely to the base and respectively aligning with the magnets, and the second magnetic unit located between the metal members; wherein
an attraction is generated between the magnets and the metal members, and
when the second magnetic unit slides to overlap the first magnetic unit, repulsion is generated between the first and second magnetic units.

10. The casing with magnetic latch as claimed in claim 9 further comprising a third magnetic unit attached securely to the base and aligning with the first magnetic unit, wherein
when the second magnetic unit stays away from the first and third magnetic units, an attraction is generated between the first and third magnetic units, and
when the second magnetic unit slides between the first and third magnetic units, repulsion is generated between the second and third magnetic units.

11. The casing with magnetic latch as claimed in claim 9 further comprising an actuating assembly connected to the base, wherein
the actuating assembly has
a seat attached securely on the base and having two side channels; and
a shell mounted slidably between the channels; and
the second magnetic unit is mounted securely in the shell.

12. The casing with magnetic latch as claimed in claim 10 further comprising an actuating assembly connected to the base, wherein the actuating assembly has
a seat attached securely on the base and having two side channels; and
a shell mounted slidably between the channels; and
the second magnetic unit is mounted securely in the shell.

13. The casing with magnetic latch as claimed in claim 11, wherein the seat has an inclined surface and the shell slides on the inclined surface.

14. The casing with magnetic latch as claimed in claim 12, wherein the seat has an inclined surface and the shell slides on the inclined surface.
